(19) United States
(12) Patent Application Publication
(10) Pub. No.: US 2010/0021605 A1
(43) Pub. Date: Jan. 28, 2010

(54) Method for cooking and cooling food products and installation for carrying out said method

(75) Inventors: Bernard Cadoret, Parc d' Activites de Broceliade (FR); Oliver Marquet, Parc d'Activites de Broceliade (FR)

Correspondence Address: BAKER & DANIELS LLP, 300 NORTH MERIDIAN STREET, SUITE 2700, INDIANAPOLIS, IN, 46204, US

(73) Assignee: Armor Inox, Mauron (FR)

(21) Appl. No.: 12/460,556

(22) Filed: Jul. 21, 2009

(30) Foreign Application Priority Data
Jul. 23, 2008 (FR) FR 08/55013

(51) Int. Cl. A23L 1/01

(52) U.S. Cl. 426/523; 99/324

(57) ABSTRACT

A method and system for processing food products in a vessel includes the steps of introducing intermediate temperature water from a first reservoir into the vessel, circulating the water and emptying it back into the first reservoir. Next, hot water from a second reservoir fills the vessel, is regulated by circulation between the second reservoir and the vessel, and is emptied back into the second reservoir. Intermediate temperature water from the first reservoir is then reintroduced into the vessel, circulated and emptied. Then, chilled water or brine from a third reservoir fills the vessel, is regulated by circulation between the third reservoir and the vessel, and is emptied back into the third reservoir.

### RELATED APPLICATIONS

The present application claims priority to French patent application serial number 08/55013, titled “Method for Cooking and Cooling Food Products and Installation for Carrying Out Said Method,” filed on Jul. 23, 2008, the entire disclosure of which is hereby expressly incorporated herein by reference.

1. Field of the Invention

The present disclosure relates to a method for cooking and cooling food products. It finds application in the field of the industrial processing of food products, of the cooked meat type and, in particular, of the type consisting of slabs or pieces of ham. The disclosure also relates to a cooking and cooling installation for carrying out such a cooking method.

2. Background

FIG. 1 shows a cooking and cooling installation 100 of the prior art. The cooking and cooling installation 100 comprises a vessel 102, in the interior of which there are moulds 104 containing slabs of meat that have to be cooked. The cooking and cooling installation 100 also comprises a hot water reservoir 106, a cold water reservoir 108 and a brine or chilled water reservoir 110.

The term “moulds” is to be understood to mean any device capable of supporting food products. These may be racks, grilles, stackable baskets, moulding units, etc.

The hot water is at a temperature Tc, which is generally around 85° C. The cold water is at a temperature Tf, which is generally around 5° C. The choice between brine and chilled water depends on the operating mode used in the cooking and cooling installation 100. The brine and the chilled water are at a temperature Tg, which is generally around 0° C. for water and −8° C. for brine.

The different temperatures depend on the operating mode used in the cooking and cooling installation 100, but they satisfy the following inequality:

Tc>Tf>Tg (1).

The vessel 102 and the reservoirs 106, 108 and 110 are connected to one another by a network of pipes, valves and pumps which make it possible to fill the vessel 102 with water coming from one of these reservoirs 106, 108 or 110 and to empty the vessel of this water which flows back into its reservoir 106, 108 or 110 of origin.

FIG. 2 shows a graph 200 showing the temperature (T) of the water or brine in the vessel 102 and of the slab of meat at its core as a function of time (t). The temperature of the water in the vessel is represented by horizontal lines and the temperature at the core of the slab of meat is represented by the curve 202.

The temperature Tc1 of the hot water in the vessel 102 is different from the temperature Tc of the hot water in the reservoir 106 due to the absorption of some of the energy by the slabs of meat and the moulds 104. The temperature Tc1 is preferably lower than the temperature Tc but remains greater than the temperature Tf.

The cooking and cooling method comprises the steps of:

introducing the moulds 104 into the vessel 102,

filling, starting from an instant t0, the vessel 102 with hot water at the temperature Tc,

regulating the temperature in the interior of the vessel 102 until an instant t1,

emptying the hot water from the vessel 102, between the instants t1 and t2,

filling, starting from the instant t2, the vessel 102 with cold water at the temperature Tf,

regulating the temperature in the interior of the vessel 102 until an instant t3,

emptying the cold water at the temperature Tf from the vessel 102, between the instants t3 and t4,

filling, starting from the instant t4, the vessel 102 with chilled water or brine at the temperature Tg,

regulating the temperature in the interior of the vessel 102 until an instant t5,

emptying the chilled water or brine at the temperature Tg from the vessel 102, after the instant t5, and

removing the moulds from the vessel 102 emptied of its water or brine.

During the step of regulating until the instant t1, the temperature reached by the core of the slab of meat is as a maximum equal to Tc1; in practice, the temperature reached by the core of the slab of meat is lower than the temperature Tc1. For example, in the case of a temperature Tc of around 85° C., the temperature Tc1 of the water in the vessel 102 is around 70° C. and the temperature of the core is around 66° C. The temperature regulation takes place by circulating water between the vessel 102 and the hot water reservoir 106, in which a temperature maintaining device regulates the temperature of the hot water at the temperature Tc. The emptying of the hot water from the vessel 102 takes place by a backflow of the water to its reservoir 106 of origin.

During the step of regulating until the instant t3, the temperature reached by the core of the slab of meat is as a minimum equal to Tf; in practice, the temperature Tf is never reached by the core of the slab of meat. The temperature regulation takes place by circulating water between the vessel 102 and the cold water reservoir 108, in which a temperature maintaining device regulates the temperature of the cold water at the temperature Tf. The emptying of the cold water at the temperature Tf from the vessel 102 takes place by a backflow of the water to its reservoir 108 of origin.

During the step of regulating until the instant t5, the temperature reached by the core of the slab of meat is as a minimum equal to Tg. The temperature regulation takes place by circulating water or brine between the vessel 102 and, respectively, the chilled water reservoir or the brine reservoir 110, in which a temperature maintaining device regulates the temperature of the chilled water or brine at the temperature Tg. The emptying of the chilled water or brine from the vessel 102 takes place by a backflow of the chilled water or brine to the reservoir 110 of origin.

Due to the timescale used for the graph 200, the instant t1 and the instant t2, on the one hand, and the instant t3 and the instant t4, on the other hand, are identical here. However, a difference exists due to the fact that a limited time is needed for the emptying and complete filling of the vessel 102.

Such a cooking and cooling method consumes the energy absorbed by the products. In particular, energy is absorbed in order to cook the food products and to heat the moulds during the cooking phase, and energy is absorbed in order to cool the food products and moulds during the cooling phase.

### SUMMARY OF THE DISCLOSURE

A method of the present disclosure for cooking and cooling food products in a vessel, comprises successively:

a step of introducing moulds containing the food products into the vessel,

a first step of introducing into the vessel water at an intermediate temperature Tr from an intermediate-temperature water reservoir,

a first step of circulating the intermediate-temperature water, thus introduced, between the vessel and said intermediate-temperature water reservoir,

a first step of emptying the vessel by a backflow of the intermediate-temperature water to the intermediate-temperature water reservoir,

a step of filling the vessel with hot water at a temperature Tc, greater than the intermediate temperature Tr, from a hot water reservoir,

a step of regulating the temperature of the water in the interior of the vessel at a temperature Tc1 by circulating the hot water, thus introduced, between the vessel and said hot water reservoir and heating the hot water, thus circulated, in said hot water reservoir,

a step of emptying the vessel by a backflow of the hot water to the hot water reservoir,

a second step of introducing into the vessel water at the intermediate temperature Tr from said intermediate-temperature water reservoir,

a second step of circulating the intermediate-temperature water, thus introduced, between the vessel and said intermediate-temperature water reservoir,

a second step of emptying the vessel by a backflow of the intermediate-temperature water to the intermediate-temperature water reservoir,

a step of filling the vessel with chilled water or brine at a temperature Tg, lower than the intermediate temperature Tr, from a chilled water or brine reservoir,

a step of regulating the temperature of the water in the interior of the vessel at the temperature Tg by circulating the chilled water or brine, thus introduced, between the vessel and said chilled water or brine reservoir and cooling the chilled water or brine, thus circulated, in said chilled water or brine reservoir,

a step of emptying the vessel by a backflow of the chilled water or brine to the chilled water or brine reservoir, and

a step of removing the moulds from the vessel emptied of its water or brine.

When there is at least one other vessel in which the same cooking and cooling method is carried out, the first step of circulation on the intermediate-temperature reservoir for said vessel is carried out in a manner synchronised with the second step of circulation on the intermediate-temperature reservoir for one of the other vessels, and the second step of circulation on the intermediate-temperature reservoir for said vessel is carried out in a manner synchronised with the first step of circulation on the intermediate-temperature reservoir for one of the other vessels.

In one embodiment, the cooking and cooling method comprises between the second step of emptying the intermediate-temperature water and the step of filling with chilled water or brine:

a step of filling the vessel with cold water at a temperature Tf, between the temperatures Tg and Tr, from a cold water reservoir,

a step of regulating the temperature of the water in the interior of the vessel at the temperature Tf by circulating the cold water, thus introduced, between the vessel and said cold water reservoir and cooling the cold water, thus circulated, in said cold water reservoir, and

a step of emptying the vessel by a backflow of the cold water to the cold water reservoir.

In one embodiment, the steps of introducing intermediate-temperature water into the vessel are carried out by sprinkling.

The present disclosure also proposes a cooking and cooling installation for food products, comprising:

a vessel designed to contain moulds containing said food products,

an intermediate-temperature water reservoir at a temperature Tr,

a hot water reservoir comprising a device for maintaining the temperature of the water at a temperature Tc greater than the temperature Tr,

a chilled water or brine reservoir comprising a device for maintaining the temperature of the water or brine at a temperature Tg lower than the temperature Tr, and

a network of pipes connecting the vessel and the reservoirs and a set of valves and pumps controlling the filling of the vessel with water coming from one of the reservoirs, the circulation of the water between the vessel and its reservoir of origin, and the emptying of this water by a backflow into its reservoir of origin.

In one embodiment, the cooking and cooling installation comprises at least one other vessel designed to contain moulds containing said food products and, for each other vessel, a second set of valves and pumps controlling the filling of said other vessel with water coming from one of the reservoirs, the circulation of the water between said other vessel and its reservoir of origin, and the emptying of this water by a backflow into its reservoir of origin.

In one embodiment, the cooking and cooling installation comprises a cold water reservoir comprising a device for maintaining the temperature of the water at a temperature Tf between the temperatures Tg and Tr.

In another embodiment, the pipe connecting the intermediate-temperature water reservoir and the vessel opens out, in said vessel, above the moulds by way of a sprinkler bar.

In yet another embodiment, the vessel comprises a ventilation system.

### BRIEF DESCRIPTION OF THE DRAWINGS

The above-mentioned features of the invention, as well as others, will become more clearly apparent upon reading the following description of an example of embodiment, said description being given in relation to the appended drawings, in which:

FIG. 1 is a schematic diagram of a cooking and cooling installation of the prior art,

FIG. 2 is a graph showing the variations in temperature as a function of time in the cooking and cooling installation of the prior art,

FIG. 3 is a schematic diagram of a cooking and cooling installation according to one embodiment of the present disclosure, and

FIG. 4 is a graph showing the variations in temperature as a function of time in the cooking and cooling installation of FIG. 3.

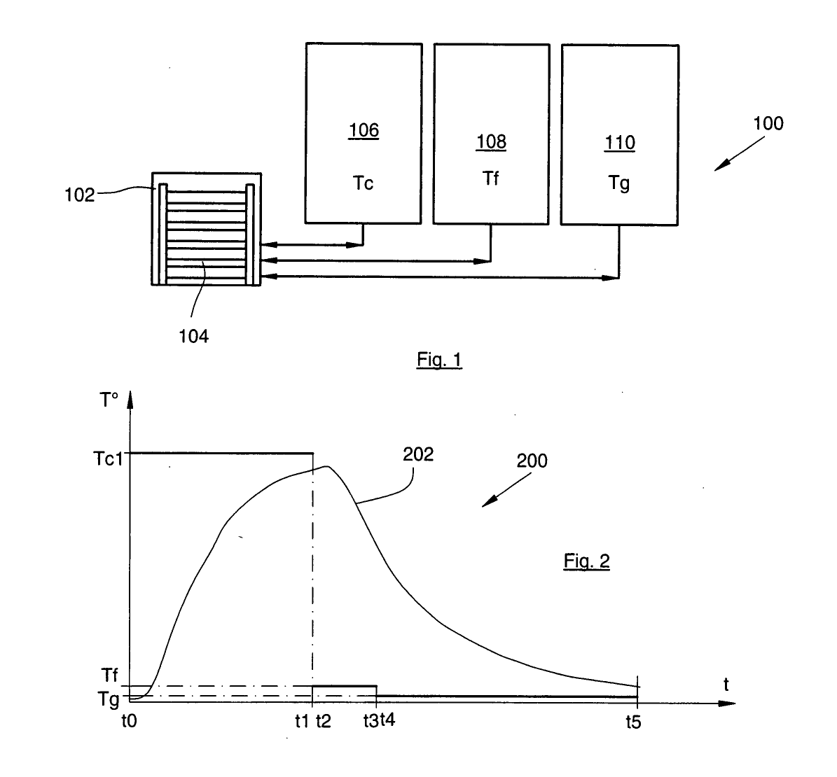

### DETAILED DESCRIPTION OF THE DISCLOSURE

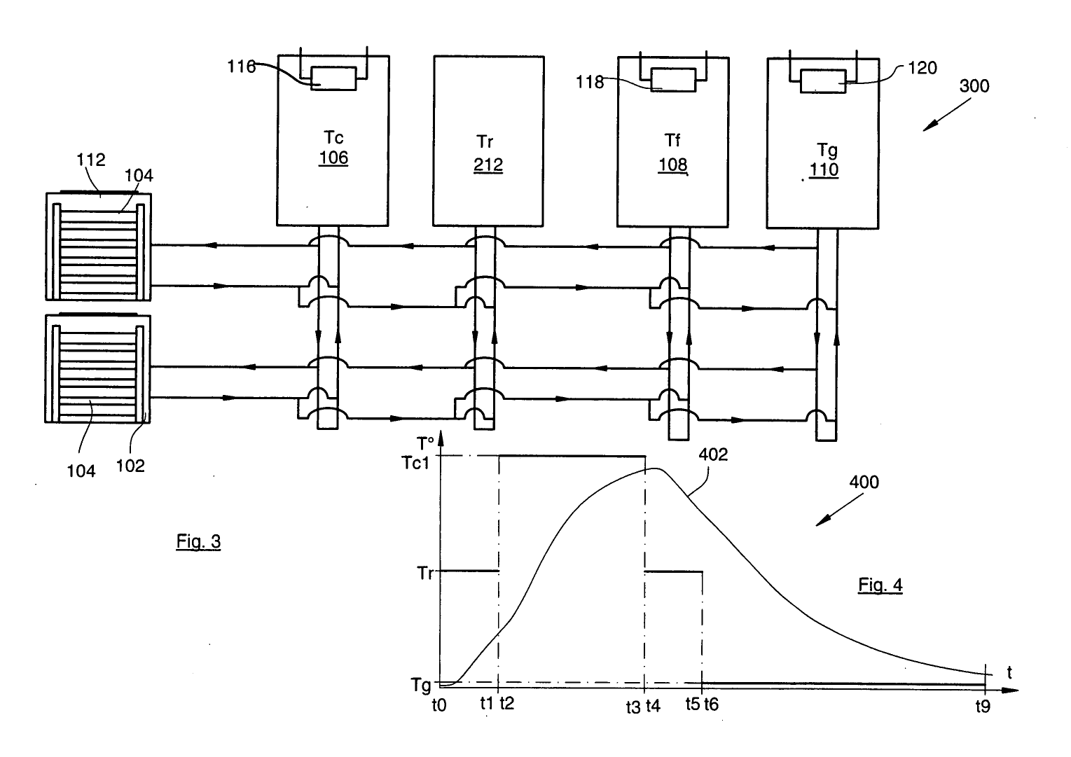

FIG. 3 shows a cooking and cooling installation 300 according to the present disclosure. The cooking and cooling installation 300 comprises, like the installation of the prior art, a vessel 102 inside which there are arranged moulds 104 containing food products, such as for example slabs of meat that have to be cooked, a hot water reservoir 106 comprising a device 116 for maintaining the temperature of the water at a temperature Tc, a cold water reservoir 108 comprising a device 118 for maintaining the temperature of the water at a temperature Tf, and a brine or chilled water reservoir 110 comprising a device 120 for maintaining the temperature of the water or brine at a temperature Tg. The cooking and cooling installation 300 also comprises an intermediate-temperature water reservoir 212. The vessel 102 is preferably closed in order to avoid energy losses.

The hot water is at a temperature Tc, which is generally around 85° C. The cold water is at a temperature Tf, which is generally around 5° C. The brine and the chilled water are at a temperature Tg, which is generally around 0° C. for water and −8° C. for brine. The intermediate-temperature water is at a temperature Tr, which is around 40° C. The different temperatures depend on the operating mode used in the cooking and cooling installation 300, but they satisfy the following inequality:

Tc>Tr>Tf>Tg (2).

The vessel 102 and the reservoirs 106, 108, 110 and 212 are connected to one another by a network of pipes connecting the vessel 102 and the reservoirs 106, 108, 110 and 212 and a set of valves and pumps which make it possible to control the opening or closing of each pipe and therefore the filling of the vessel 102 with water coming from one of these reservoirs 106, 108, 110 or 212, the circulation of the water between the vessel 102 and its reservoir 106, 108, 110 or 212 of origin, and the emptying of this water by a backflow to its reservoir 106, 108, 110 or 212 of origin.

The arrows indicate the direction of displacement of the water in the pipes. The valves and the pumps are not shown, but the person skilled in the art knows to use such elements in order to allow the circulation of the water.

The device 116 for maintaining the temperature of the water at the temperature Tc is for example of the heating device type. The device 118 for maintaining the temperature of the water at the temperature Tf and the device 120 for maintaining the temperature of the water or brine at the temperature Tg are for example of the heat exchanger type.

In one particular embodiment, the cold water reservoir 108 is not used.

FIG. 4 shows a graph 400 showing the temperature (T) of the water or brine in the vessel 102 and of the slab of meat at its core as a function of time t. The temperature of the water in the vessel 102 is represented by continuous bold lines, and the temperature at the core of the slab of meat is represented by the curve 402. As above, the temperature Tc1 of the hot water in the vessel 102 is lower than the temperature Tc of the hot water in the reservoir 106 but remains greater than the temperature Tr. For example, the temperature Tc1 is around 70° C. for a temperature Tc of around 85° C.

The cooking and cooling method according to the invention comprises successively:

a step of introducing moulds 104 containing the food products into the vessel 102,

a first step of introducing into the vessel 102 water at the intermediate temperature Tr from the intermediate-temperature water reservoir 212,

a first step of circulating the intermediate-temperature water, thus introduced, between the vessel 102 and the intermediate-temperature water reservoir 212,

a first step of emptying the vessel 102 by a backflow of the intermediate-temperature water to the intermediate-temperature water reservoir 212,

a step of filling the vessel 102 with hot water at the temperature Tc from the hot water reservoir 106,

a step of regulating the temperature of the water in the interior of the vessel 102 at the temperature Tc1 by circulating the hot water, thus introduced, between the vessel 102 and the hot water reservoir 106 and heating the hot water, thus circulated, in said hot water reservoir 106,

a step of emptying the vessel 102 by a backflow of the hot water to the hot water reservoir 106,

a second step of introducing into the vessel 102 water at the intermediate temperature Tr from the intermediate-temperature water reservoir 212,

a second step of circulating the intermediate-temperature water, thus introduced, between the vessel 102 and the intermediate-temperature water reservoir 212,

a second step of emptying the vessel 102 by a backflow of the intermediate-temperature water to the intermediate-temperature water reservoir 212,

a step of filling the vessel 102 with chilled water or brine at the temperature Tg from the chilled water or brine reservoir 110,

a step of regulating the temperature of the water in the interior of the vessel 102 at the temperature Tg by circulating the chilled water or brine, thus introduced, between the vessel 102 and the chilled water or brine reservoir 110 and cooling the chilled water or brine, thus circulated, in the chilled water or brine reservoir 110,

a step of emptying the vessel 102 by a backflow of the chilled water or brine to the chilled water or brine reservoir 110, and

a step of removing the moulds from the vessel 102 emptied of its water or brine.

Of course, each regulating step is carried out only when the temperature of the water in the vessel 102 differs from the reference temperature Tc1, Tg. For example, in the case of the hot water, the maintaining of the temperature at the value Tc1 is carried out when the temperature of the water in the vessel 102 is too low compared to Tc1. The hot water is then circulated. If the temperature in the interior of the vessel 102 is greater than or equal to the temperature Tc1, no circulation is carried out. On the other hand, it is possible to activate the pump in the vessel 102 and to open the appropriate valves so as to stir the hot water in the vessel 102.

The first step of introducing water at the intermediate temperature Tr is carried out at an instant t0.

The first step of circulating the water at the intermediate temperature Tr is carried out between the instant t0 and an instant t1.

The first step of emptying the water at the intermediate temperature Tr is carried out between the instant t1 and an instant t2.

The step of filling the vessel 102 with hot water is carried out at the instant t2.

The step of regulating at the temperature Tc1 is carried out between the instant t2 and an instant t3.

The step of emptying the hot water is carried out between the instant t3 and an instant t4.

The second step of introducing water at the intermediate temperature Tr is carried out at the instant t4.

The second step of circulating the water at the intermediate temperature Tr is carried out between the instant t4 and an instant t5.

The second step of emptying the water at the intermediate temperature Tr is carried out between the instant t5 and an instant t6.

The step of filling the vessel 102 with chilled water or brine is carried out at the instant t6.

The step of regulating at the temperature Tg is carried out between the instant t6 and an instant t9.

The step of emptying the chilled water or brine is carried out at the instant t9.

In one embodiment, in which the cold water reservoir 108 and the water at the temperature Tf are used, the cooking and cooling method comprises between the second step of emptying the intermediate-temperature water and the step of filling with chilled water or brine:

a step of filling the vessel 102 with cold water at the temperature Tf from the cold water reservoir 108,

a step of regulating the temperature of the water in the interior of the vessel 102 at the temperature Tf by circulating the cold water, thus introduced, between the vessel 102 and the cold water reservoir 108 and cooling the cold water, thus circulated, in the cold water reservoir 108, and

a step of emptying the vessel 102 by a backflow of the cold water to the cold water reservoir 108.

Each step of regulating at a given temperature in the vessel 102 gives rise to an energy consumption necessary for the operation of the relevant temperature maintaining device 116, 118, 120 in order to maintain the given temperature in the reservoir 106, 108, 110 in question. The regulating steps are understood to mean steps during which the temperature at the core of the slabs of meat increases or decreases or is constant, depending on the desired regulation mode.

By contrast, the intermediate-temperature water reservoir 212 does not comprise any temperature maintaining device; it is the use of the same reservoir and of the same water during the first step of circulation on the reservoir 212 at the intermediate temperature Tr and during the second step of circulation on the reservoir 212 at the intermediate temperature Tr that makes it possible to save energy. This is because, during the first circulation step, the water is at a temperature which decreases due to the heating of the food products. This decrease in temperature of the water in the intermediate-temperature water reservoir 212 is compensated by an increase in the temperature of the water during the second circulation step. This is because, during the second circulation step, the water is at a temperature which increases due to the cooling of the food products and of the moulds. It is therefore not necessary to regulate the temperature of the water at the intermediate temperature Tr by using a temperature maintaining device.

In other words, the energy absorbed by the food products and moulds during the first circulation step and the energy dissipated by the food products and moulds during the second circulation step are not involved in the energy balance of the method. The energy dissipated during the second step of circulation on the reservoir 212 at the intermediate temperature Tr heats the water which heats the food products and moulds during the first step of circulation on the reservoir 212 at the intermediate temperature Tr and, conversely, the energy absorbed during the first step of circulation on the reservoir 212 at the intermediate temperature Tr gives rise to a cooling of the water which cools the food products during the second step of circulation on the reservoir 212 at the intermediate temperature Tr. The energy saving over one complete cycle of the cooking and cooling method is around 38% when each circulation step lasts approximately 1 hour.

The above-described variations in temperature of the water in the intermediate-temperature water reservoir 212 are not seen in FIG. 4, since the latter shows an embodiment in which the installation 300 comprises at least one other vessel 112 in which the same cooking and cooling method according to the invention is carried out. Said other vessels 112 are also designed to contain moulds 104 containing the food products, and the installation 300 also comprises, for each other vessel 112, a second set of valves and pumps controlling the filling of said other vessel 112 with water coming from one of the reservoirs 106, 108, 110 or 212, the circulation of the water between said other vessel 112 and its reservoir 106, 108, 110 or 212 of origin, and the emptying of this water by a backflow into its reservoir 106, 108, 110 or 212 of origin. Said other vessels 112 are connected to the same network of pipes as the vessel 102.

In this embodiment, the first step of circulation on the reservoir 212 at the intermediate temperature Tr for the vessel 102 is carried out in a manner synchronised with the second step of circulation on the reservoir 212 at the intermediate temperature Tr for one of the other vessels 112, and the second step of circulation on the reservoir 212 at the intermediate temperature Tr for the vessel 102 is carried out in a manner synchronised with the first step of circulation on the reservoir 212 at the intermediate temperature Tr for one of the other vessels 112.

A natural equilibrium is thus created at a target temperature for the storage temperature Tr. The intermediate-temperature water coming from said other vessel 112 will heat the water from the intermediate-temperature water reservoir 212, while the intermediate-temperature water coming from said vessel 102 will cool it. Therefore, as above, the method according to the invention does not require any step of regulating the temperature by means of a temperature maintaining device of the heat exchanger type. Of course, it is possible to combine more than two vessels 102, 112.

The first step of circulation for the vessel 102 is said to be synchronised with the second step of circulation if they take place simultaneously or if they are slightly offset from one another without appreciably disrupting the heat exchange.

If an excessive instability of the temperature Tr is observed, given the temperature range in which it is located, it is still possible to install a heat exchanger of small size with low operating costs.

The instants t1 and t2, t3 and t4, t5 and t6 are shown here at the same points because of the scale, but they are all different in reality. This is because one complete cycle of the method of the invention lasts between 8 and 24 hours, while the emptying and filling of the vessel 102 lasts approximately 15 minutes.

As explained above, it is not necessary to use a temperature maintaining device which regulates the temperature of the intermediate-temperature water in the intermediate-temperature water reservoir 212.

According to one particular embodiment, the steps of introducing intermediate-temperature water into the vessel 102 are filling operations which are carried out by means of a flow through the pipe connecting the reservoir 212 and the vessel 102.

According to another particular embodiment, the steps of introducing intermediate-temperature water into the vessel 102 are carried out by a sprinkling of the moulds 104 and of the slabs of meat. To this end, the pipe connecting the intermediate-temperature water reservoir 212 and the vessel 102 opens out, in said vessel 102, above the moulds 104 by way of a sprinkler bar or spray bar. In this embodiment, a ventilation system may be installed in the vessel 102. This ventilation system optimises the dispersion of calories by exploiting the energy associated with the vaporisation of the water.

Of course, the present disclosure is not limited to the examples and embodiments described and shown, but rather is susceptible to numerous variants accessible to the person skilled in the art.

1. A method for cooking and cooling food products in a vessel, including the steps of:
(i) introducing moulds containing food products into the vessel;
(ii) introducing water at a first temperature Tr from a first reservoir into the vessel;
(iii) circulating the first temperature water between the vessel and the first reservoir;
(iv) emptying the vessel into the first reservoir;
(v) filling the vessel with water at a second temperature Tc from a second reservoir, wherein Tc>Tr;
(vi) regulating the water at a temperature Tc1 by circulating the second temperature water between the vessel and the second reservoir and heating the second temperature water in the second reservoir;
(vii) emptying the vessel into the second reservoir;
(viii) introducing water at a first temperature Tr from a first reservoir into the vessel;
(ix) circulating the first temperature water between the vessel and the first reservoir;
(x) emptying the vessel into the first reservoir;
(xi) filling the vessel with a liquid at a third temperature Tg from a third reservoir, wherein Tg<Tr;
(xii) regulating the liquid at Tg by circulating the liquid between the vessel and the third reservoir and cooling the liquid in the third reservoir;
(xiii) emptying the vessel into the third reservoir, and
(xiv) after step (xiii), removing the moulds from the vessel.

2. The method of claim 1, wherein the liquid is one of water and brine.

3. The method of claim 1, wherein, when the method is used for cooking and cooling food products in another vessel, step (iii) for the vessel is synchronized with step (ix) for the other vessel and step (ix) for the vessel is synchronized with step (iii) for one of the other vessel.

4. The method of claim 1, further including between steps (x) and (xi) the steps of
filling the vessel with water at a fourth temperature Tf for a fourth reservoir, wherein Tg<Tf<Tr,
regulating the water at Tf by circulating the water between the vessel and the fourth reservoir and cooling the water in the fourth reservoir, and
emptying the vessel into the fourth reservoir.

5. The method of claim 1, wherein steps (ii) and (viii) are carried out by sprinkling.

6. An installation for cooking and cooling food products, including:
a vessel configured to contain moulds including the food products;
a first reservoir including liquid at a temperature Tr;
a second reservoir including a device for maintaining liquid at a temperature Tc, wherein Tc>Tr;
a third reservoir including a device for maintaining liquid at a temperature Tg, wherein Tg<Tr;
a plurality of pipes connecting the vessel and the reservoirs; and
a set of valves and pumps configured to control the filling of the vessel with liquid from the reservoirs, the circulation of the liquid between the vessel and its reservoir of origin, and the emptying of the liquid into its reservoir of origin.

7. The installation of claim 6, wherein the liquid in the third reservoir is one of water and brine.

8. The installation of claim 6, further including a second vessel (112) configured to contain moulds including food products, and a second set of valves and pumps configured to control the filling of the second vessel with liquid from the reservoirs, the circulation of the liquid between the second vessel and its reservoir of origin, and the emptying of the liquid into its reservoir of origin.

9. The installation of claim 6, further including a fourth reservoir including a device for maintaining liquid at a temperature Tf, wherein Tg<Tf<Tr.

10. The installation of claim 6, wherein the plurality of pipes includes a first pipe connecting the first reservoir and the vessel, the first pipe having a sprinkler bar opening disposed in the vessel above the moulds.

11. The installation of claim 6, wherein the vessel includes a ventilation system.

12. A method for processing food products in a vessel, including the steps of:
(i) introducing food products into the vessel;
(ii) circulating water at a first temperature Tr between the vessel and a first reservoir;
(iii) emptying the vessel;
(iv) circulating water at a second temperature Tc between the vessel and a second reservoir and heating the second temperature water in the second reservoir, wherein Tc>Tr;
(v) emptying the vessel into the second reservoir;
(vi) circulating the first temperature water between the vessel and the first reservoir;
(vii) emptying the vessel;
(viii) circulating water at a third temperature Tg between the vessel and a third reservoir and cooling the water in the third reservoir, wherein Tg<Tr; and
(ix) emptying the vessel into the third reservoir.
